(19) United States
(12) Patent Application Publication
(10) Pub. No.: US 2025/0217918 A1
(43) Pub. Date: Jul. 3, 2025

(54) SEMI-FRAGILE NEURAL WATERMARKS FOR MEDIA AUTHENTICATION AND COUNTERING DEEPFAKES

(71) Applicant: The Regents of the University of California, Oakland, CA (US)

(72) Inventors: Shehzeen Samarah Hussain, San Diego, CA (US); Paarth Neekhara, San Diego, CA (US); Farinaz Koushanfar, San Diego, CA (US); Xinqiao Zhang, San Diego, CA (US); Julian McAuley, San Diego, CA (US)

(21) Appl. No.: 18/850,041

(22) PCT Filed: Mar. 23, 2023
(86) PCT No.: PCT/US2023/016154

§ 371 Date: Sep. 23, 2024

Related U.S. Application Data
(60) Provisional application No. 63/323,470, filed on Mar. 24, 2022.

(51) Int. Cl. G06T 1/00; G06F 21/16

(52) U.S. Cl. CPC G06T 1/0042; G06F 21/16

(57) ABSTRACT

In some implementations, there is provided a method comprising: receiving an image and a digital watermark; outputting a watermarked image generated based on the image and the digital watermark; selecting, from a set of benign transforms, a benign transform; selecting, from a set of malicious transforms, a malicious transform; performing the benign transform on the watermarked image to generate a benign image; performing the malicious transform on the watermarked image to generate a malicious image; decoding, by a decoder, the benign image to a first predicted value of the digital watermark; decoding, by the decoder, the malicious image to a second predicted value of the digital watermark; and adjusting at least one weight of the decoder during a learning phase of the decoder.

### CROSS-REFERENCE TO RELATED APPLICATION

This application is a national stage entry of Patent Cooperation Treaty Application No. PCT/US2023/016154 filed Mar. 23, 2023, entitled “SEMI-FRAGILE NEURAL WATERMARKS FOR MEDIA AUTHENTICATION AND COUNTERING DEEPFAKES,” which claims priority to U.S. Provisional Application No. 63/323,470 filed Mar. 24, 2022, entitled “FACESIGNS: SEMI-FRAGILE NEURAL WATERMARKS FOR MEDIA AUTHENTICATION AND COUNTERING DEEPFAKES”. The disclosures of which are incorporated herein by reference in their entirety.

### TECHNICAL FIELD

This disclosure generally relates to machine learning.

### BACKGROUND

Deepfakes and manipulated media are becoming a prominent threat due to the recent advances in realistic image and video synthesis techniques. There have been several attempts at combating deepfakes using machine learning classifiers. However, the machine learning classifiers may not generalize well to unseen synthetic media and can be shown to be vulnerable to adversarial examples even in black box attack settings.

### SUMMARY

In some example embodiments, there may be provided a machine learning based semi-fragile watermarking technique that allows media authentication by verifying semi-fragile watermark embedded in at least a portion of an image.

In some example embodiments, there is provided a computer-implemented method, comprising: receiving, at an encoder, an image and a digital watermark; outputting, by the encoder, a watermarked image generated based on the image and the digital watermark; selecting, from a set of benign transforms, a benign transform; selecting, from a set of malicious transforms, a malicious transform; performing the benign transform on the watermarked image to generate a benign image; performing the malicious transform on the watermarked image to generate a malicious image; decoding, by a decoder, the benign image to a first predicted value of the digital watermark; decoding, by the decoder, the malicious image to a second predicted value of the digital watermark; and adjusting at least one weight of the decoder during a learning phase of the decoder by at least learning a minimum amount of error between the first predicted value, which corresponds to the benign image, and the digital watermark and learning a maximum amount of error between the second predicted value, which corresponds to the malicious image, and the digital watermark.

In some variations, one or more features disclosed herein including the following features can optionally be included in any feasible combination. The encoder may be trained to minimize an error between the image and the watermarked image, wherein the error comprises an image reconstruction loss and/or an adversarial loss. The training to minimize the error between the image and the watermarked image may further include using a discriminator to determine the adversarial loss indicative of whether the watermarked image is the image. The encoder may include a convolutional neural network and/or a U-NET, and wherein the decoder may include a convolutional neural network and/or a U-NET. The benign transform may be selected from a set of benign transforms comprising an image compression of the watermarked image, a color adjustment of the watermarked image, a lighting adjustment of the watermarked image, a contrast adjustment of the watermarked image, a downsizing of the watermarked image, an upsizing of the watermarked image transformation, a horizontal and/or vertical translation of the watermarked image, and/or a rotation of the watermarked image. The malicious transform may replace an image portion of a subject of the watermarked image with another image portion, and/or wherein the malicious transform may replace at least a portion of face image of the subject of the watermarked image with another face portion. The malicious transform may use a mask that replaces at least a portion of the watermarked image with another image portion. The first predicted value of the digital watermark and/or the second predicted to the digital watermark may be compared to determine whether the watermarked image has been maliciously transformed. The digital watermark may include an encrypted message, wherein the encrypted message may be generated using a key and a message. The encoder may receive a plurality of images to enable the learning phase of the decoder. The adjusting may further include adjusting at least one weight of an encoder during the learning phase.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A shows an example of a system for generating a watermark for an image, in accordance with some embodiments;

FIG. 1B depicts example of malicious tampering of a watermarked image, in accordance with some embodiments;

FIG. 1C depicts another example of the decoder, in accordance with some embodiments;

FIG. 2 depicts an example of a system that uses machine learning to train an encoder and a decoder to use the semi-fragile watermark, in accordance with some embodiments;

FIG. 3 depicts examples of a mask used to maliciously transform a watermarked image, in accordance with some embodiments;

FIG. 4 depicts an example of a process for semi-fragile watermarks, in accordance with some embodiments; and

FIG. 5 depicts an example of a system, in accordance with some embodiments.

### DETAILED DESCRIPTION

To address some of the challengers related to deepfakes and other types of malicious tampering of images, there is provided a machine learning (ML) based semi-fragile watermarking technique that allows media authentication by verifying an invisible secret message (e.g., a semi-fragile watermark) embedded in the image. The watermarking is semi-fragile in the sense that the watermark breaks (e.g., shows evidence of tampering), when the watermarked image is processed or transformed in a malicious manner but the watermark does not break when the watermarked image is processed or transformed in a benign manner. In this way, the semi-fragile watermark may be used to detect media, such as images, frames of video, and/or the like, that have been processed using, for example, deepfake media (e.g., using fake visual artifacts such as face or other body part swaps in an image). Moreover, the semi-fragile watermark may be used to verify media that is authentic (e.g., without the insertion of visual artifacts) or media being modified with benign transformations.

In some embodiments, the semi-fragile watermark is designed to be fragile to insertion of visual objects or artifacts, such as facial manipulations or insertions, while being robust to benign image-processing operations, such as image compression, scaling, saturation, contrast adjustments, and/or the like. The semi-fragile watermark may thus allow images (which are shared over the Internet) to retain a verifiable semi-fragile watermark, so long as the malicious image processing/transformations (e.g., face-swapping and/or other deepfake modification/generation techniques) are not applied to the images.

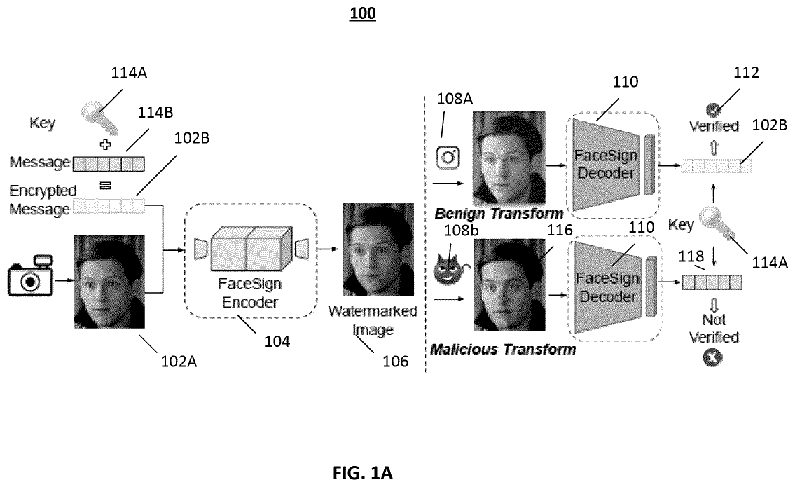

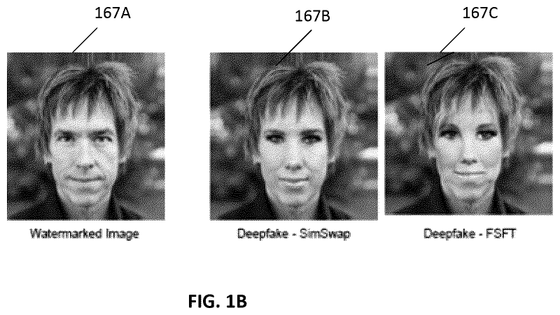

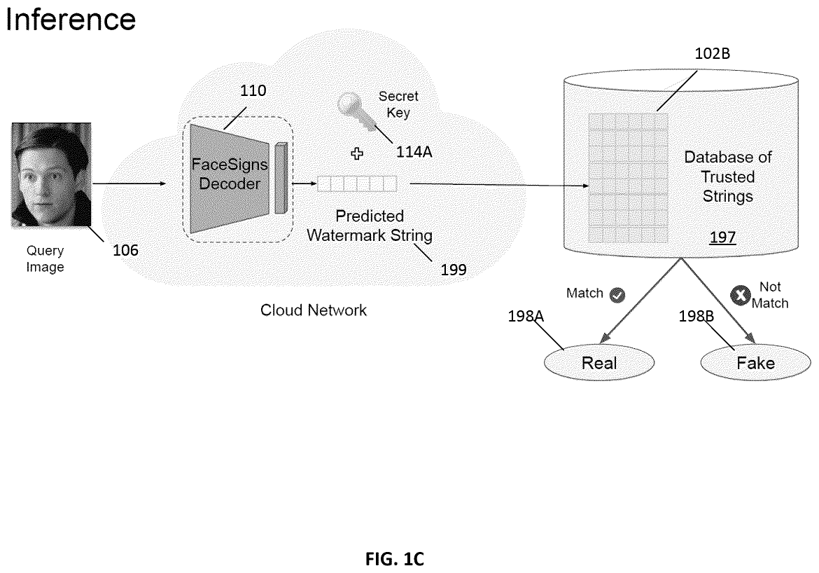

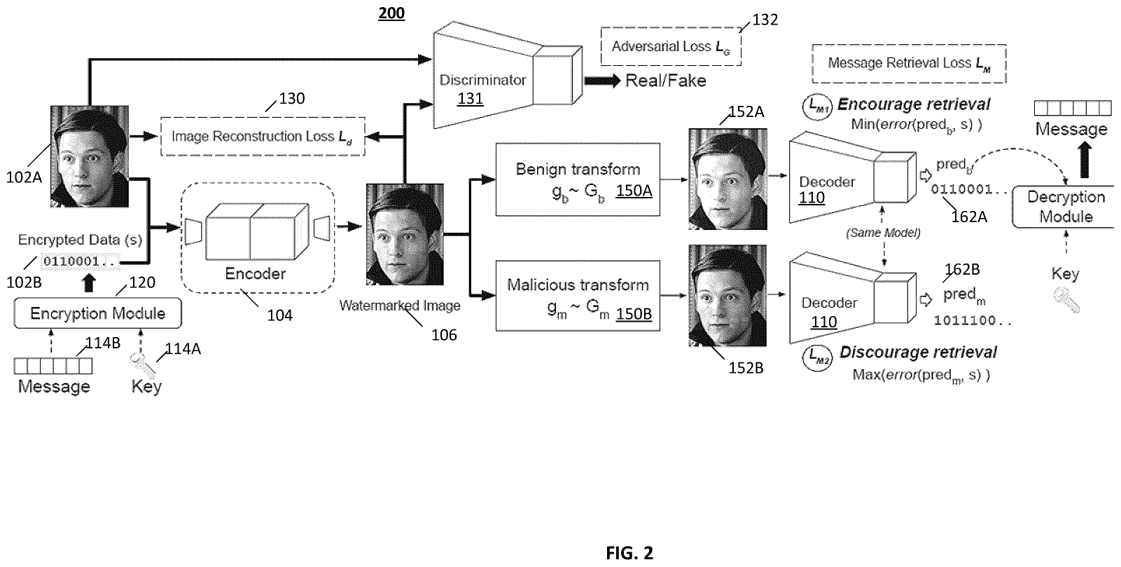

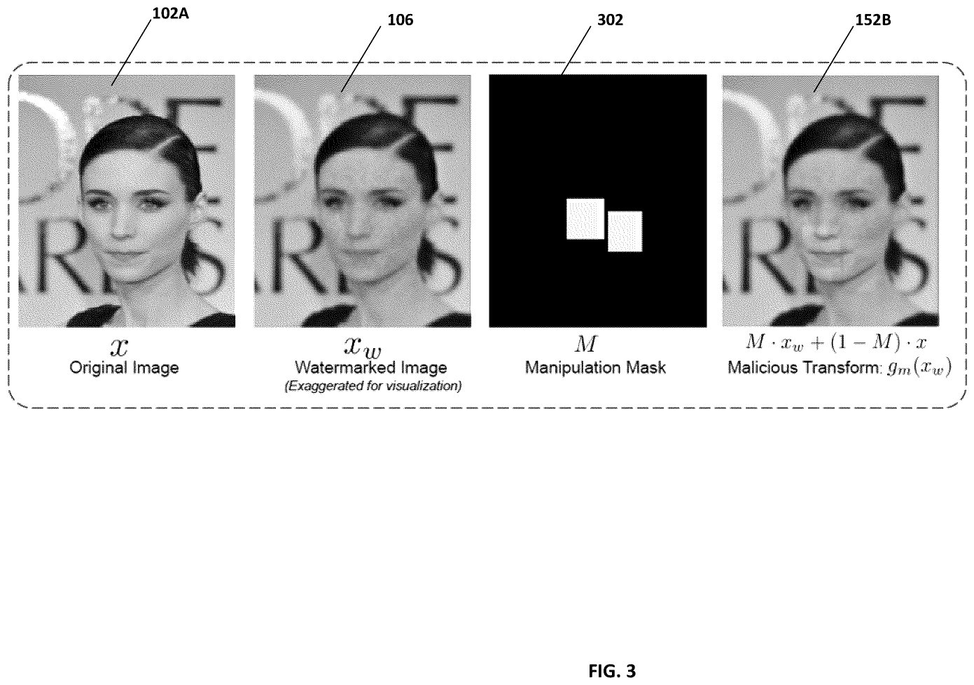

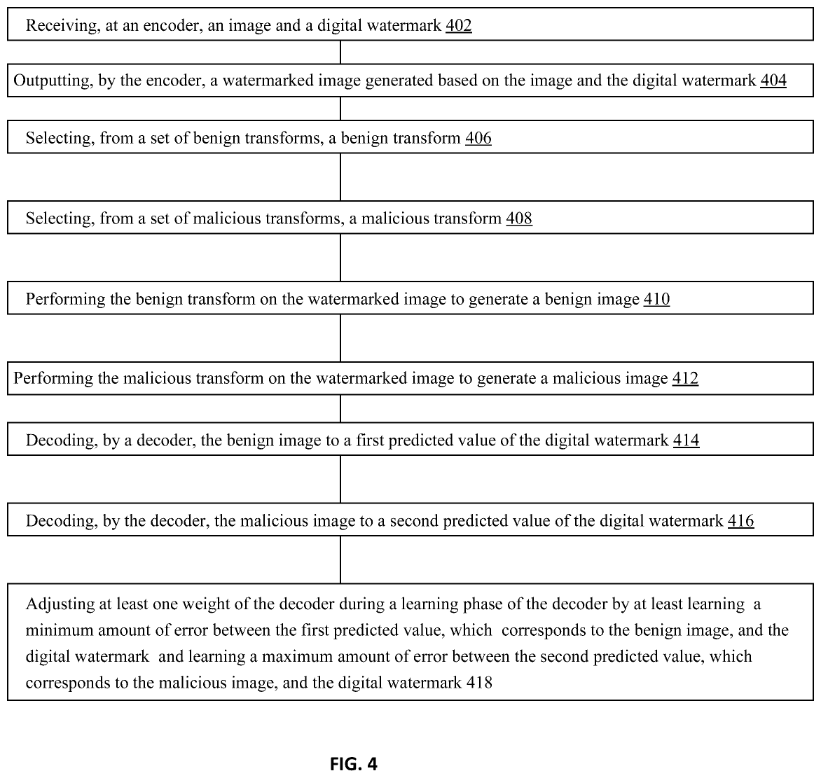

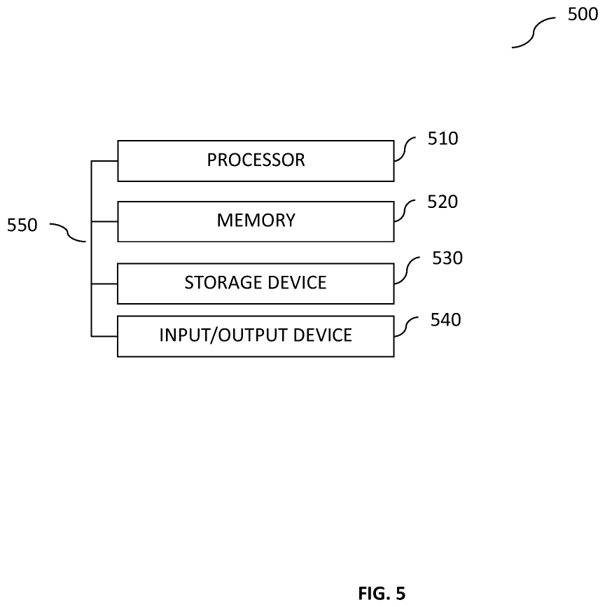

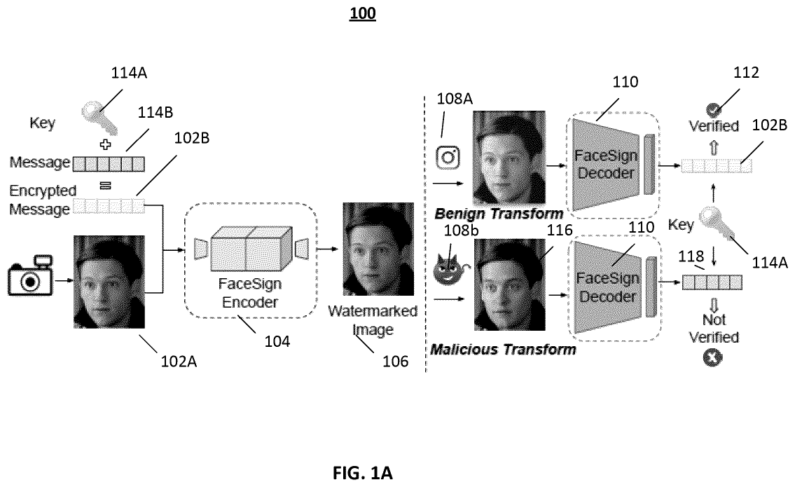

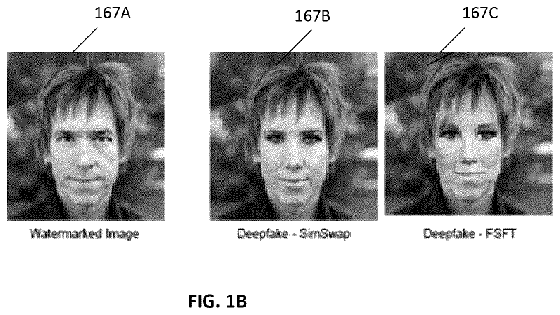

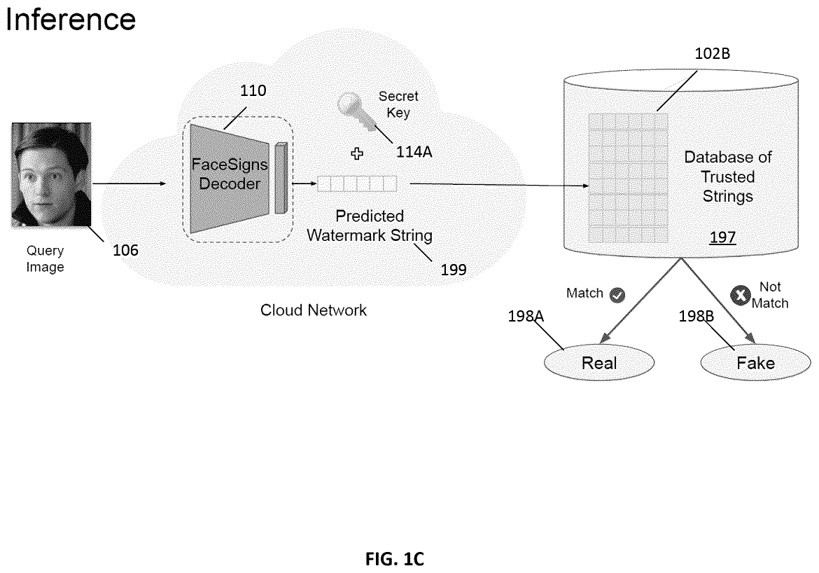

FIG. 1A shows an example of a system 100 for generating a watermark for an image, in accordance with some embodiments.

In the example of FIG. 1A, the encoder 104 receives an image 102A and an encrypted message 102B, and the encoder outputs a watermarked image 106. The encrypted message 102B is generated by applying a key, such as an encryption key 114A to a message 114B. In the example of FIG. 1A, the encoder 104 and decoder 110 are each implemented using ML models, such as a convolutional neural network, a U-Net CNN, and/or other types of ML models. The U-Net is a type of CNN which includes a contracting path and an expansive path, wherein the contracting path follows a convolutional neural network framework.

The encoder 104 encodes (e.g., embeds) the encrypted message 102B into the image 102A as an imperceptible semi-fragile watermark that is designed to be robust against benign image transformations and photo editing tools but fragile towards malicious image manipulations, such as deepfake image manipulations (e.g., which changes a subjects face). This watermark is referred to herein as a semi-fragile watermark. The watermark embeds a recoverable message (or, e.g., a value) as a perturbation in the image's pixels, wherein the perturbation is not readily discernable or not perceptible. FIG. 1B depicts example of watermarked images 167A and the corresponding deepfakes 167B-C.

Referring again to FIG. 1A, although FIG. 1A refers to 102B as an encrypted message, other types of digital watermarks or digital codes (e.g., secret codes, device specific codes, and/or the like) can be used to watermark an image. Moreover, although FIG. 1A depicts watermarking an image, the watermarking may be applied to video and/or one or more frames of a video.

FIG. 1A shows that if the watermarked image 106 undergoes a benign transformation at 108, the decoder 110 is able to verify 112 the watermark (e.g., the verification 112 decrypts the message 102B using the key 114A and determines that message 102B matches message 114B). However, if the watermarked image 106 undergoes a malicious transformation at 108b, the decoder 110 is not able to verify 112 the watermark (e.g., the decryption of the secret message using the key 114A yields a message that does not match message 114B). In the example of FIG. 1A, the verification 112 decrypts the secret message (or semi-fragile watermark) using the original key 114A to reveal the original, unencrypted message 114B.

Examples of benign image transformations include image compression, color adjustments, lighting adjustments, and/or other image manipulations to watermarked image 106A that do not attempt to insert objects or artifacts into the watermarked image 106. For example, if the watermarked image 106 is shared over the Internet with other users, compressing the watermarked image will still allow the watermarked image to be verified. Examples of malicious transformation include face swapping (e.g. where an image or video is processed to replace or manipulate a subject's face with another person's face, and/or other image manipulations that insert objects or artifacts into the watermarked image 106. For example, if watermarked image 106 is shared over the Internet with other users and a face manipulation is performed as shown at FIG. 1B, the watermark will not be verified.

In the example of FIG. 1A, the encoder 104 and the decoder 110 are each implemented using a ML model (e.g., a convolutional neural network, U-Net CNN, and/or the like) trained to verify the watermark of a watermarked image undergoing a benign transformation but not verifying the watermark of a watermarked image undergoing a malicious transformation.

FIG. 1C depicts another example of the decoder 110, in accordance with some embodiments. In the example of FIG. 1C, the decoder has been trained to verify the input watermarked image 106. For example, if the watermarked image has been transformed in a benign way, the watermarked image will be verified but if the watermarked image has been maliciously transformed, the watermarked image will not be verified.

In the example of FIG. 1C, the decoder 110 maybe provided as a service, such as a cloud service (e.g., remote service coupled to the Internet), such that when the decoder receives an image, such as watermarked image 106, the output is a predicted digital watermark 199, which is decrypted by the secret key 114A. If the decrypted digital watermark matches one of the “trusted strings” such as message or string 102B (which is stored at the database 197), the watermarked image 106 is real and thus verified at 198A. But if the decrypted digital watermark does not match one of the “trusted strings” (which is stored at the database 197), the watermarked image 106 is fake and thus not verified at 198B.

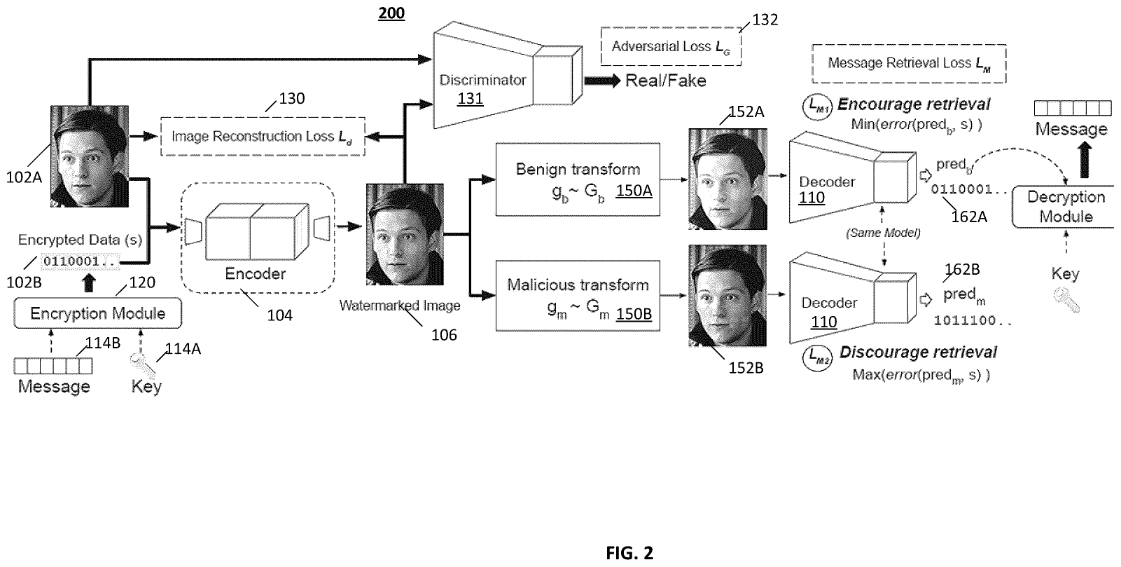

FIG. 2 depicts an example of a system 200 using machine learning to train the encoder 104 and the decoder 110 to use a semi-fragile watermark that is robust to benign transforms of a watermarked image but breaks the watermark when a watermarked image is manipulated in a malicious manner. In the example of FIG. 2, the encoder and decoder are each ML models trained by encouraging message retrieval for watermarked images that have undergone benign transformations and discouraging retrieval from maliciously transformed watermarked images.

In the example of FIG. 2, an encryption module 120 generates encrypted data 102B (which is used as a watermark) using the encryption key 114A that is applied to a message 114B. In the example of FIG. 2, the encoder 104 encodes the image 102A using the encrypted data 102B and outputs the watermarked image 106.

To enhance the imperceptibility that the watermarked image 106 has been modified with a watermark, the system may compare the watermarked image 106 with the original image 102A to determine an image reconstruction loss 130 and an adversarial loss 132, which is generated as an output by the discriminator 131. These losses are used to train and thus adjust the encoder 104 (e.g., the weights of the encoder). For example, the discriminator may be a classifier that tries to distinguish between the original, real image 102A and the watermarked image 106.

In the example of FIG. 2, the encoder 104 Ex (also referred to as an encoder network), the decoder D_{β} 110 (also referred to as a decoder network), and the discriminator A_{γ} 131 (also referred to as an adversarial discriminator network), where α, β and γ are learnable parameters during ML training. In other words, the encoder, decoder, and discriminator are ML models that are trained in a ML training phase of the encoder, decoder, and the discriminator. During training, the encoder and decoder networks may be jointly trained to optimize the message recovery loss, which encourages the retrieval of benign transforms while discouraging retrieval of malicious transforms. The encoder network is also optimized to minimize image reconstruction loss. At the same time for example, a discriminator network is trained to distinguish between real and watermarked images, and the encoder network is further trained to bypass the discriminator, which enhances the imperceptibility of the generated watermark.

The encoder network 104 may receive the watermarking data at 102B as a bit string s of length L. This watermarking data may, as noted, contain information about the device that captured the image or may be a secret or encrypted message that can be used to authenticate the image. To prevent adversaries (who have gained white-box access to the encoder network) from encoding a target message, the message 114B may be encrypted using symmetric or asymmetric encryption algorithms or hashing. For example, encrypted messages of size 128 bits are used, which allows the network to encode 2128 unique messages.

During training, the encoder network E 104 receives as input x (e.g., the image 102A) and receives a bit string s∈{0,1}^{L} of length L (e.g., encrypted data 102B) and generates as an output an encoded image, such as watermarked image x_{w} 106 (e.g., x_{w}=E(x, s)). In some embodiments, the watermarked image 106 may then go through at least two image transformations 150A and 150B. For example, the watermarked image 106 may undergo a benign transformation 150A to form a first transformed image 152A (e.g., a benign image x_{b}=g_{b} (x_{w})), and the watermarked image 106 may undergo a malicious transformation 150B to form a second transformed image 152B (e.g., malicious image xₘ=gₘ (x_{w})).

In some embodiments, there may be a set of benign transformations (g_{b} ˜G_{b}) and a set of malicious transformations (gₘ˜Gₘ) to produce a benign image x_{b}=g_{b} (x_{w}) and malicious image xₘ=gₘ(x_{w}). When this is the case, one of the set of benign transformations may be selected and applied to the watermarked image 106 and one or the set of malicious transformations may be selected and applied to the watermarked image 106. In some embodiments, the selection of the benign transformation is random, semi-random, or in a predetermined pattern. In some embodiments, the selection of the malicious transformation is random, semi-random, or in a predetermined pattern. To ensure robust ML training of the decoder 110, the selection may seek to use each of the benign transformations in the set of benign transformation, and use each of the malicious transformations in the set of malicious transformation.

The benign and malicious watermarked images 152A are then fed to the decoder network 110, which predicts the output, which is a message 162A (e.g., s_{b}=D(x_{b})) and a message 162B (e.g., sₘ=D(xₘ)). These messages 162A-B correspond to the watermark, such as the original encrypted message 102B, which when decrypted with the key 114A should reveal the original message 114B (if the watermark is intact). During training, the ML model for the decoder learns by encouraging (e.g., minimizing the error between the predicted message 162A and the original encrypted data 102B) retrieval of the watermark for the benign transformation. But for the malicious transform, the ML model decoder training discourages (e.g., maximize the error between the predicted message 162B and the original encrypted data 102B) retrieval of the watermark.

With respect to the discriminator 131, the watermarked image 106 is encouraged to look visually similar to the original image 102A by optimizing image distortion metrics, such as L₁, L₂ and Lₚᵢₚₛ distortions. Moreover, an adversarial loss L_{G} 132 (e.g., L_{G}(x_{w})=log (1−A(x_{w}))) from the discriminator 131 may also be used to during training to distinguish original images from watermarked images. For example, the image reconstruction loss L_{img} is obtained as follows:

$${L}_{d} ( x , {x}_{w} ) = {L}_{1} ( x , {x}_{w} ) + {L}_{2} ( x , {x}_{w} ) + {c}_{p} {L}_{pips} ( x , {x}_{w} ) \qquad ( 1 )$$

$${L}_{img} ( x , {x}_{w} ) = {L}_{d} ( x , {x}_{w} ) + {c}_{g} {L}_{G} ( {x}_{w} )$$

The decoder 110 is, as noted, encouraged during training to be robust to the benign transformations by minimizing the message distortion L_{M}(s,s_{b}) but fragile for malicious manipulations by maximizing the error L_{M}(s,sₘ). The L₁ distortion between the predicted and ground-truth bit string may be used to optimize the message prediction error L_{M} during training. Therefore, the parameters α, β of the encoder and decoder network may be trained using mini-batch gradient descent to optimize the following loss over a distribution of input messages and images:

$${𝔼}_{x , s , {g}_{l} , {g}_{m}} [ {L}_{img} ( x , {x}_{w} ) + {c}_{b} {L}_{M} ( s , {s}_{b} ) = {c}_{m} {L}_{M} ( s , {s}_{m} ) ] , \qquad ( 2 )$$

wherein cₚ, c_{g}, c_{b} and cₘ are scalar coefficients for the respective loss terms.

The discriminator 131 parameters γ may be trained to distinguish original images x from watermarked images x_{w} as follows:

$${𝔼}_{x , s} [ log ( 1 - A ( x ) ) + log ( A ( {x}_{w} ) ) ] . \qquad ( 3 )$$

The encoder 104 and the decoder 110 may each comprise a ML model, such as convolutional neural network (CNN), a U-Net CNN, and/or the like. In an implementation of FIG. 2, the ML model is configured to operate on 256×256 images. The encrypted messages 102B (which is an L length bit string) is first projected to a tensor s_{Proj} of size 96×96 using a trainable fully connected layer, resized to 256×256 using bilinear interpolation, and then added as a fourth channel to the original RGB image 102A to be fed as an input to the encoder network. For example, the encoder 104 (which in this example is a U-Net) contains 8 down-sampling and 8 upsampling layers. The U-Net architecture may be modified by replacing the transposed convolution in the upsampling layers with convolutions followed by nearest-neighbor upsampling. The decoder network may also be configured using a similar architecture as the encoder network. For example, the decoder 110 (which in this example is a U-Net) first outputs a 256×256 intermediate output, which is downsized to 96×96 using bilinear down-sampling to produce s_{ProjDecoded} and then projected to vector of size L using a fully connected layer followed by a sigmoid layer to scale values between 0 and 1. For the first few mini-batch iterations during ML training, another auxiliary loss may be used to minimize the mean squared error between s_{Proj} and s_{ProjDecoded} for benign transformations. This may help stabilize the training by encouraging message recovery early on during the training process.

As noted above, there may be a set of benign transformation and a set of malicious transformation functions. Although an example set of benign transformations and an example set of malicious transformations are described herein, the disclosed sets are merely an example as additional (or fewer) transformation may be used during training of the system of FIG. 2.

With respect to benign transforms, these transforms tend to be transforms that are not malicious. As such, a goal of training is to authenticate using the watermark images that undergo benign transforms, such as color adjustments, lighting adjustments, and/or the like. To approximate standard image processing distortions that an image may undergo, the set of benign image transformations (Gb) are used during training.

The set of benign transformation may include a Gaussian Blur transformation, a compression (e.g., JPEG) transformation, a saturation transformation, a contrast adjustment transformation, a downsizing (and/or upsizing) transformation, and/or a translation (and/or rotation) transformation.

The benign Gaussian blur transformation may provide a blur to the original image by convolving the original image with a Gaussian kernel k. This transform is given by t(x)=k*x where * is the convolution operator and a kernel size ranging from k=3 to k=7.

The benign compression transformation may compress (e.g., using JPEG) the original image. During training, the original image may be transformed using for example JPEG compression with quality 40, 60 and 80.

The benign compression transformation may compress (e.g., using H.264 or MJPEG codec or neural network-based video compression model) frames of the original video. During training, the original video frame may be transformed using for example neural network-based video compression.

The benign saturation adjustments transformation may account for various color adjustments and filters (e.g., social media filters) by randomly linearly interpolating between the original (e.g., full RGB) image and its grayscale equivalent.

The benign contrast adjustments transformation may be performed by linearly rescaling the image histogram and thus contrast using a contrast factor.

The benign downsizing and upsizing transformation may downsize an image (e.g., by a factor scale) and then up sampled by the same factor using bilinear upsampling.

The benign translation and rotation transformation may shift horizontally and vertically the original image by a given amount of pixels and rotate the image by given amount of degrees. For each mini-batch iteration during ML model training of the encoder, decoder, and discriminator, at least one transformation may be selected from the benign and/or malicious transformations and the selected transform(s) may be applied to the images in the batch.

With respect to malicious transform, an aim is to generate semi-fragile watermarks that are un-recoverable when objects in an image are inserted (or removed) into the original image, such as image compositing, background replacement, facial tampering, face swapping, and/or other GAN based manipulations are applied. In the case of deepfakes using facial manipulation, the facial manipulation may be defined as selectively tampering certain regions of the face to modify a facial appearance or identity. To simulate such tampering during training, a random tampering mask (e.g., of zeros and ones) may be generated, such that the mask indicates the regions of the watermarked image to retain or discard. This technique is referred as facial watermark occlusion.

During facial watermark occlusion, the watermark in the facial regions of the image are transformed (or tampered with) by mixing some region of the watermarked image with the original image. For each image, a mask M_{h×w×c} is initialed with of all ones. Next, n patches of size Pₕ×P_{w} are selected in the facial region of the image, and the values of all pixels in the patches are set to a small watermark retention percentage wᵣ∈[0,1]. That is, M[i, j, :]=wᵣ for all i, j in the selected patches. And, the maliciously transformed image gₘ(x_{w}) is obtained as follows:

$${g}_{m} ( {x}_{w} ) = M \cdot {x}_{w} + ( 1 - M ) \cdot x .$$

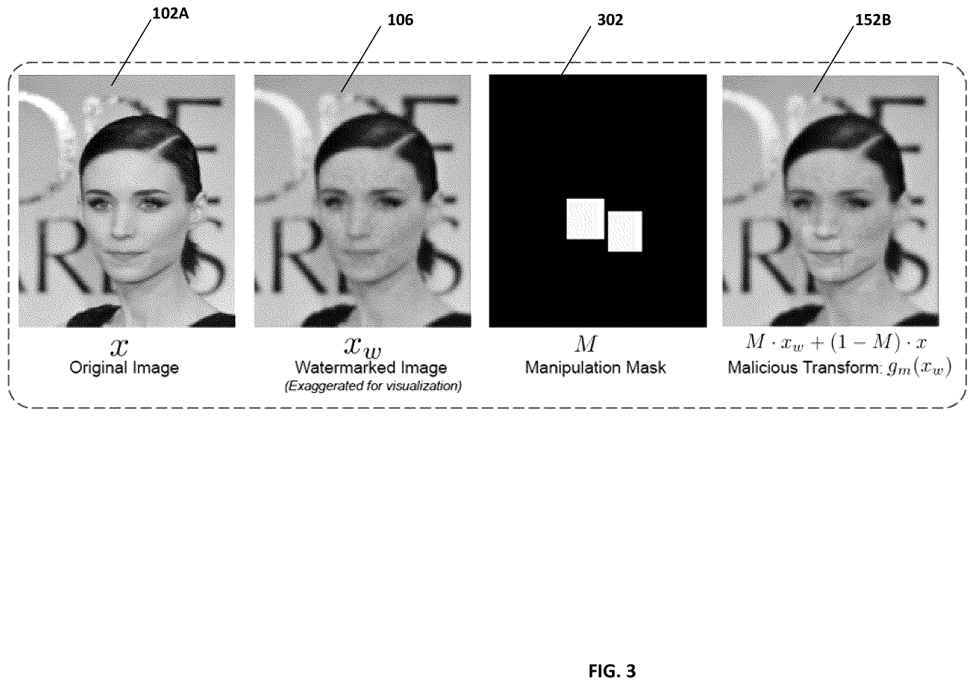

FIG. 3 depicts the original image x 102A, the watermarked image x_{w} 106, an example the mask 302 used to maliciously manipulate the watermarked image, and the maliciously transformed image 152B. An underlying assumption behind facial watermark occlusion is that deepfake manipulations modify the facial regions such as eyes, lips and nose thereby tampering the watermark in those regions.

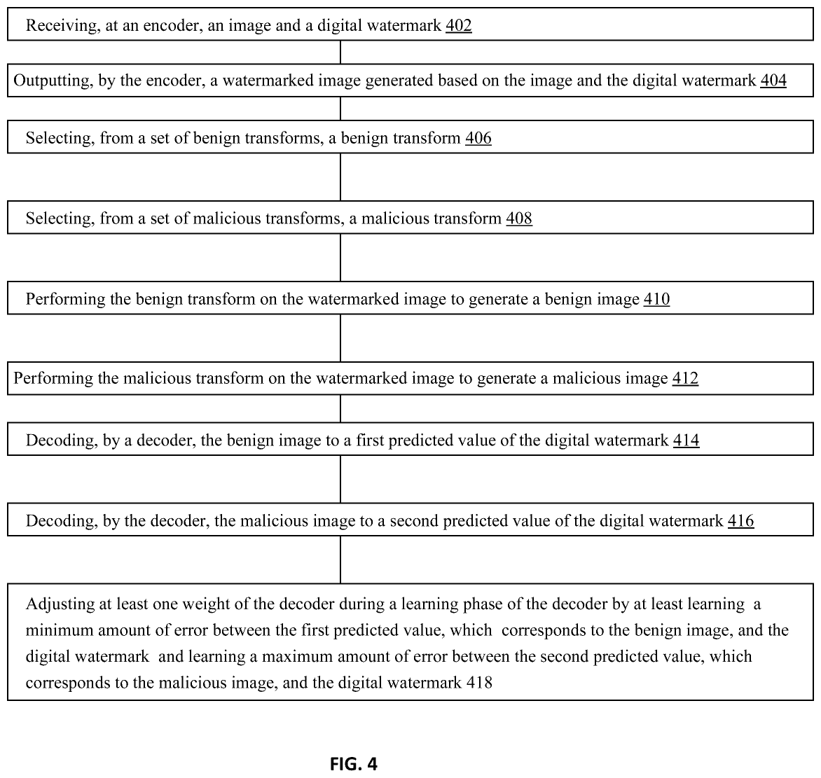

FIG. 4 depicts an example of a process, in accordance with some embodiments.

At 402, an encoder may receive an image and a digital watermark, in accordance with some embodiments. Referring to the example of FIG. 2, the encoder 104 may receive an image 102A and a digital watermark, such as the encrypted data 102B.

At 404, the encoder may output a watermarked image generated based on the image and the digital watermark, in accordance with some embodiments. Referring again to the example of FIG. 2, the encoder 104 may encode the received inputs and generate (based on the inputs) an output, which comprises the watermarked image 106.

At 406, a benign transform may be selected from a set of benign transforms, in accordance with some embodiments. For example, the benign transform 150A may be selected from a set of benign transforms. The set may include 1 or more benign transforms. The set of benign transforms may include an image compression of the watermarked image, a color adjustment of the watermarked image, a lighting adjustment of the watermarked image, a contrast adjustment of the watermarked image, a downsizing of the watermarked image, an upsizing of the watermarked image transformation, a horizontal and/or vertical translation of the watermarked image, and/or a rotation of the watermarked image. The

At 408, a malicious transform may be selected from a set of malicious transforms, in accordance with some embodiments. For example, the malicious transform 150B may be selected from a set of malicious transforms. The set may include 1 or more benign transforms. For example, the malicious transform which is selected may replaces an image portion of a subject of the watermarked image with another image portion as shown in the examples of FIG. 1B. Alternatively, or additionally, the malicious transform uses a mask that replaces at least a portion of the watermarked image with another image portion as depicted at FIG. 3.

At 410, the benign transform is performed on the watermarked image to generate a benign image, in accordance with some embodiments. For example, the benign transform 150A may be applied to the watermarked image 106 to form a benign image 152A.

At 412, the malicious transform is performed on the watermarked image to generate a malicious image, in accordance with some embodiments. For example, the malicious transform 150BA may be applied to the watermarked image 106 to form a malicious image 152B.

At 414, the decoder may decode the benign image to a first predicted value of the digital watermark, in accordance with some embodiments. Referring again to FIG. 2, the decoder 110 may decode the input benign image 152A into a predicted value 162A.

At 416, the decoder may decode the malicious image to a second predicted value of the digital watermark, in accordance with some embodiments. Referring again to FIG. 2, the decoder 110 may decode the input malicious image 152B into a predicted value 162B.

At 418, at least one weight of the decoder may be adjusted during a learning phase of the decoder by at least learning a minimum amount of error between the first predicted value (which corresponds to the benign image) and the digital watermark and learning a maximum amount of error between the second predicted value (which corresponds to the malicious image) and the digital watermark, in accordance with some embodiments. As noted, the decoder 110 is encouraged during training to be robust to the benign transformation by for example minimizing the message distortion L_{M}(s,s_{b}) but fragile to malicious transformation by for example maximizing the error L_{M}(s, sₘ).

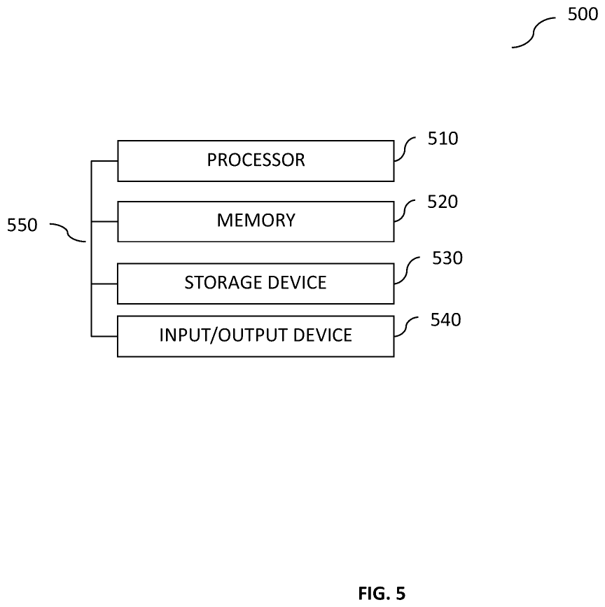

In some implementations, the current subject matter may be configured to be implemented in a system 500, as shown in FIG. 5. For example, the ML models used for the encoders, decoders, and/or discriminators may comprise or be comprised in system 500. The system 500 may include a processor 510, a memory 520, a storage device 530, and an input/output device 540. Each of the components 510, 520, 530 and 540 may be interconnected using a system bus 550. The processor 510 may be configured to process instructions for execution within the system 500. In some implementations, the processor 510 may be a single-threaded processor. In alternate implementations, the processor 510 may be a multi-threaded processor. The processor may be a multi-core processor having a plurality of processors or a single core processor. Alternatively, or additionally, the processor can be a graphics processor unit (GPU), an AI chip, an/or the like.

The processor 510 may be further configured to process instructions stored in the memory 520 or on the storage device 530, including receiving or sending information through the input/output device 540. The memory 520 may store information within the system 500. In some implementations, the memory 520 may be a computer-readable medium. In alternate implementations, the memory 520 may be a volatile memory unit. In yet some implementations, the memory 520 may be a non-volatile memory unit. The storage device 530 may be capable of providing mass storage for the system 500. In some implementations, the storage device 530 may be a computer-readable medium. In alternate implementations, the storage device 530 may be a floppy disk device, a hard disk device, an optical disk device, a tape device, non-volatile solid state memory, or any other type of storage device. The input/output device 540 may be configured to provide input/output operations for the system 500. In some implementations, the input/output device 540 may include a keyboard and/or pointing device. In alternate implementations, the input/output device 540 may include a display unit for displaying graphical user interfaces.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:
Example 1: A computer-implemented method, comprising: receiving, at an encoder, an image and a digital watermark; outputting, by the encoder, a watermarked image generated based on the image and the digital watermark; selecting, from a set of benign transforms, a benign transform; selecting, from a set of malicious transforms, a malicious transform; performing the benign transform on the watermarked image to generate a benign image; performing the malicious transform on the watermarked image to generate a malicious image; decoding, by a decoder, the benign image to a first predicted value of the digital watermark; decoding, by the decoder, the malicious image to a second predicted value of the digital watermark; and adjusting at least one weight of the decoder during a learning phase of the decoder by at least learning a minimum amount of error between the first predicted value, which corresponds to the benign image, and the digital watermark and learning a maximum amount of error between the second predicted value, which corresponds to the malicious image, and the digital watermark.
Example 2: The computer-implemented method of Example 1 further comprising: training, the encoder, to minimize an error between the image and the watermarked image, wherein the error comprises an image reconstruction loss and/or an adversarial loss.
Example 3: The computer-implemented method of any of Examples 1-2, wherein the training to minimize the error between the image and the watermarked image further comprises using a discriminator to determine the adversarial loss indicative of whether the watermarked image is the image.
Example 4: The computer-implemented method of any of Examples 1-3, wherein the encoder comprises a convolutional neural network and/or a U-NET, and wherein the decoder comprises a convolutional neural network and/or a U-NET.
Example 5: The computer-implemented method of any of Examples 1-4, wherein the benign transform is selected from a set of benign transforms comprising an image compression of the watermarked image, a color adjustment of the watermarked image, a lighting adjustment of the watermarked image, a contrast adjustment of the watermarked image, a downsizing of the watermarked image, an upsizing of the watermarked image transformation, a horizontal and/or vertical translation of the watermarked image, and/or a rotation of the watermarked image.
Example 6: The computer-implemented method of any of Examples 1-5, wherein the malicious transform replaces an image portion of a subject of the watermarked image with another image portion, and/or wherein the malicious transform replaces at least a portion of face image of the subject of the watermarked image with another face portion.
Example 7: The computer-implemented method of any of Examples 1-6, wherein the malicious transform uses a mask that replaces at least a portion of the watermarked image with another image portion.
Example 8: The computer-implemented method of any of Examples 1-7, further comprising: comparing the first predicted value of the digital watermark and/or the second predicted to the digital watermark to determine whether the watermarked image has been maliciously transformed.
Example 9: The computer-implemented method of any of Examples 1-8, wherein the digital watermark comprises an encrypted message, wherein the encrypted message is generated using a key and a message.
Example 10: The computer-implemented method of any of Examples 1-9, wherein the encoder receives a plurality of images to enable the learning phase of the decoder.
Example 11: The computer-implemented method of any of Examples 1-10, wherein the adjusting further comprises adjusting at least one weight of an encoder during the learning phase.
Example 12: A system, comprising: at least one data processor; and at least one memory storing instructions which, when executed by the at least one data processor, cause operations comprising: receiving, at an encoder, an image and a digital watermark; outputting, by the encoder, a watermarked image generated based on the image and the digital watermark; selecting, from a set of benign transforms, a benign transform; selecting, from a set of malicious transforms, a malicious transform; performing the benign transform on the watermarked image to generate a benign image; performing the malicious transform on the watermarked image to generate a malicious image; decoding, by a decoder, the benign image to a first predicted value of the digital watermark; decoding, by the decoder, the malicious image to a second predicted value of the digital watermark; and adjusting at least one weight of the decoder during a learning phase of the decoder by at least learning a minimum amount of error between the first predicted value, which corresponds to the benign image, and the digital watermark and learning a maximum amount of error between the second predicted value, which corresponds to the malicious image, and the digital watermark.
Example 13: The system of Example 12 further comprising: training, the encoder, to minimize an error between the image and the watermarked image, wherein the error comprises an image reconstruction loss and/or an adversarial loss.
Example 14: The system of any of Examples 12-13, wherein the training to minimize the error between the image and the watermarked image further comprises using a discriminator to determine the adversarial loss indicative of whether the watermarked image is the image.
Example 15: The system of any of Examples 12-14, wherein the encoder comprises a convolutional neural network and/or a U-NET, and wherein the decoder comprises a convolutional neural network and/or a U-NET.
Example 16: The system of any of Examples 12-15, wherein the benign transform is selected from a set of benign transforms comprising an image compression of the watermarked image, a color adjustment of the watermarked image, a lighting adjustment of the watermarked image, a contrast adjustment of the watermarked image, a downsizing of the watermarked image, an upsizing of the watermarked image transformation, a horizontal and/or vertical translation of the watermarked image, and/or a rotation of the watermarked image.
Example 17: The system of any of Examples 12-16, wherein the malicious transform replaces an image portion of a subject of the watermarked image with another image portion, and/or wherein the malicious transform replaces at least a portion of face image of the subject of the watermarked image with another face portion.
Example 18: The system of any of Examples 12-17, wherein the malicious transform uses a mask that replaces at least a portion of the watermarked image with another image portion.
Example 19: The system of any of Examples 12-18, further comprising: comparing the first predicted value of the digital watermark and/or the second predicted to the digital watermark to determine whether the watermarked image has been maliciously transformed.
Example 20: The system of any of Examples 12-19, wherein the digital watermark comprises an encrypted message, wherein the encrypted message is generated using a key and a message.
Example 21: The system of any of Examples 12-20, wherein the encoder receives a plurality of images to enable the learning phase of the decoder.
Example 22: The system of any of Examples 12-21, wherein the adjusting further comprises adjusting at least one weight of an encoder during the learning phase.
Example 23: A non-transitory computer-readable medium including instructions which, when executed by at least one data processor, cause operations comprising: receiving, at an encoder, an image and a digital watermark; outputting, by the encoder, a watermarked image generated based on the image and the digital watermark; selecting, from a set of benign transforms, a benign transform; selecting, from a set of malicious transforms, a malicious transform; performing the benign transform on the watermarked image to generate a benign image; performing the malicious transform on the watermarked image to generate a malicious image; decoding, by a decoder, the benign image to a first predicted value of the digital watermark; decoding, by the decoder, the malicious image to a second predicted value of the digital watermark; and adjusting at least one weight of the decoder during a learning phase of the decoder by at least learning a minimum amount of error between the first predicted value, which corresponds to the benign image, and the digital watermark and learning a maximum amount of error between the second predicted value, which corresponds to the malicious image, and the digital watermark.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed:

1. A computer-implemented method, comprising:
receiving, at an encoder, an image and a digital watermark;
outputting, by the encoder, a watermarked image generated based on the image and the digital watermark;
selecting, from a set of benign transforms, a benign transform;
selecting, from a set of malicious transforms, a malicious transform;
performing the benign transform on the watermarked image to generate a benign image;
performing the malicious transform on the watermarked image to generate a malicious image;
decoding, by a decoder, the benign image to a first predicted value of the digital watermark;
decoding, by the decoder, the malicious image to a second predicted value of the digital watermark; and
adjusting at least one weight of the decoder during a learning phase of the decoder by at least learning a minimum amount of error between the first predicted value, which corresponds to the benign image, and the digital watermark and learning a maximum amount of error between the second predicted value, which corresponds to the malicious image, and the digital watermark.

2. The computer-implemented method of claim 1 further comprising:
training, the encoder, to minimize an error between the image and the watermarked image, wherein the error comprises an image reconstruction loss and/or an adversarial loss.

3. The computer-implemented method of claim 2, wherein the training to minimize the error between the image and the watermarked image further comprises using a discriminator to determine the adversarial loss indicative of whether the watermarked image is the image.

4. The computer-implemented method of claim 1, wherein the encoder comprises a convolutional neural network and/or a U-NET, and wherein the decoder comprises a convolutional neural network and/or a U-NET.

5. The computer-implemented method of claim 1, wherein the benign transform is selected from a set of benign transforms comprising an image compression of the watermarked image, a color adjustment of the watermarked image, a lighting adjustment of the watermarked image, a contrast adjustment of the watermarked image, a downsizing of the watermarked image, an upsizing of the watermarked image transformation, a horizontal and/or vertical translation of the watermarked image, and/or a rotation of the watermarked image.

6. The computer-implemented method of claim 1, wherein the malicious transform replaces an image portion of a subject of the watermarked image with another image portion, and/or wherein the malicious transform replaces at least a portion of face image of the subject of the watermarked image with another face portion.

7. The computer-implemented method of claim 1, wherein the malicious transform uses a mask that replaces at least a portion of the watermarked image with another image portion.

8. The computer-implemented method of claim 1, further comprising:
comparing the first predicted value of the digital watermark and/or the second predicted to the digital watermark to determine whether the watermarked image has been maliciously transformed.

9. The computer-implemented method of claim 1, wherein the digital watermark comprises an encrypted message, wherein the encrypted message is generated using a key and a message.

10. The computer-implemented method of claim 1, wherein the encoder receives a plurality of images to enable the learning phase of the decoder.

11. The computer-implemented method of claim 1, wherein the adjusting further comprises adjusting at least one weight of an encoder during the learning phase.

12. A system, comprising:
at least one data processor; and
at least one memory storing instructions which, when executed by the at least one data processor, cause operations comprising:
receiving, at an encoder, an image and a digital watermark;
outputting, by the encoder, a watermarked image generated based on the image and the digital watermark;
selecting, from a set of benign transforms, a benign transform;
selecting, from a set of malicious transforms, a malicious transform;
performing the benign transform on the watermarked image to generate a benign image;
performing the malicious transform on the watermarked image to generate a malicious image;
decoding, by a decoder, the benign image to a first predicted value of the digital watermark;
decoding, by the decoder, the malicious image to a second predicted value of the digital watermark; and
adjusting at least one weight of the decoder during a learning phase of the decoder by at least learning a minimum amount of error between the first predicted value, which corresponds to the benign image, and the digital watermark and learning a maximum amount of error between the second predicted value, which corresponds to the malicious image, and the digital watermark.

13. The system of claim 12 further comprising:
training, the encoder, to minimize an error between the image and the watermarked image, wherein the error comprises an image reconstruction loss and/or an adversarial loss.

14. The system of claim 13, wherein the training to minimize the error between the image and the watermarked image further comprises using a discriminator to determine the adversarial loss indicative of whether the watermarked image is the image.

15. The system of claim 12, wherein the encoder comprises a convolutional neural network and/or a U-NET, and wherein the decoder comprises a convolutional neural network and/or a U-NET.

16. The system of claim 12, wherein the benign transform is selected from a set of benign transforms comprising an image compression of the watermarked image, a color adjustment of the watermarked image, a lighting adjustment of the watermarked image, a contrast adjustment of the watermarked image, a downsizing of the watermarked image, an upsizing of the watermarked image transformation, a horizontal and/or vertical translation of the watermarked image, and/or a rotation of the watermarked image.

17. The system of claim 12, wherein the malicious transform replaces an image portion of a subject of the watermarked image with another image portion, and/or wherein the malicious transform replaces at least a portion of face image of the subject of the watermarked image with another face portion.

18. The system of claim 12, wherein the malicious transform uses a mask that replaces at least a portion of the watermarked image with another image portion.

19. The system of claim 12, further comprising:
comparing the first predicted value of the digital watermark and/or the second predicted to the digital watermark to determine whether the watermarked image has been maliciously transformed, wherein the digital watermark comprises an encrypted message, wherein the encrypted message is generated using a key and a message, wherein the encoder receives a plurality of images to enable the learning phase of the decoder, wherein the adjusting further comprises adjusting at least one weight of an encoder during the learning phase.

20. A non-transitory computer-readable medium including instructions which, when executed by at least one data processor, cause operations comprising:
receiving, at an encoder, an image and a digital watermark;
outputting, by the encoder, a watermarked image generated based on the image and the digital watermark;
selecting, from a set of benign transforms, a benign transform;
selecting, from a set of malicious transforms, a malicious transform;
performing the benign transform on the watermarked image to generate a benign image;
performing the malicious transform on the watermarked image to generate a malicious image;
decoding, by a decoder, the benign image to a first predicted value of the digital watermark;
decoding, by the decoder, the malicious image to a second predicted value of the digital watermark; and
adjusting at least one weight of the decoder during a learning phase of the decoder by at least learning a minimum amount of error between the first predicted value, which corresponds to the benign image, and the digital watermark and learning a maximum amount of error between the second predicted value, which corresponds to the malicious image, and the digital watermark.
